(19) United States
(12) Patent Application Publication
(10) Pub. No.: US 2026/0128419 A1
(43) Pub. Date: May 7, 2026

(54) ENERGY STORAGE DEVICE

(71) Applicant: TOYOTA JIDOSHA KABUSHIKI KAISHA, Toyota-shi (JP)

(72) Inventors: Makoto IWATA, Toyota-shi (JP); Shotaro Ishikawa, Miyoshi-shi (JP); Shunsuke Fujiwara, Toyota-shi (JP); Soichiro Nakamura, Toyota-shi (JP); Takahiko Nakano, Toyota-shi (JP); Kosuke Suzuki, Toyota-shi (JP); Masahiro Ishizuka, Toyota-shi (JP); Kensuke Matsuo, Seto-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 19/314,051

(22) Filed: Aug. 29, 2025

(30) Foreign Application Priority Data
Nov. 6, 2024 (JP) 2024-194424

(51) Int. Cl. H01M 10/658; H01M 50/342; H01M 50/367; H01M 50/375

(52) U.S. Cl. CPC H01M 10/658; H01M 50/3425; H01M 50/367; H01M 50/375

(57) ABSTRACT

An energy storage device includes at least one energy storage cell, a bottom wall, a panel member provided below the bottom wall, and a protective member provided on the bottom wall. A safety valve is provided in a lower surface of the energy storage cell. The bottom wall has a through hole provided at a position facing the safety valve. The protective member includes a thermal insulation member provided within the through hole. The thermal insulation member includes a receiving surface located below an upper surface of the bottom wall.

### CROSS-REFERENCE TO RELATED APPLICATION

This application claims priority to Japanese Patent Application No. 2024-194424 filed on Nov. 6, 2024. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

For example, Japanese Unexamined Patent Application Publication (Translation of PCT Application) No. 2024-501935 (JP 2024-501935 A) discloses an electrical device including a plurality of battery cells, a first housing that houses the battery cells, a second housing that houses the first housing, and an isolation member provided within the second housing. The isolation member supports the first housing at a position above the bottom surface of the second housing. The second housing includes a collection cavity under the isolation member. A third fragile area is provided on the lower surface of each battery cell, and a pressure relief area is provided on the bottom surface of the first housing, and a second fragile area is provided on the isolation member. A material discharged from any of the battery cells through the third fragile area of the battery cell flows through the pressure relief area and the second fragile area into the collection cavity formed under the isolation member.

### SUMMARY

In the electrical device described in JP 2024-501935 A, it takes time for the material discharged from the battery cell through the third fragile area to crack open the pressure relief area and the second fragile area. Therefore, there is a concern that part of the contents (so-called debris) of the battery cell contained in the discharged material may scatter into the space between the battery cell and the first housing without passing through the pressure relief area and the second fragile area.

An object of the present disclosure is to provide an energy storage device that can reduce scattering of the contents of an energy storage cell contained in a material discharged from the electricity storage cell.

An energy storage device according to one aspect of the present disclosure includes: at least one storage cell; a bottom wall disposed below the at least one energy storage cell; a panel member provided below the bottom wall and defining, together with the bottom wall, an exhaust path; and a protective member provided on the bottom wall. A safety valve is provided in a lower surface of the at least one energy storage cell. The bottom wall has a through hole provided at a position facing the safety valve. The protective member includes a thermal insulation member provided within the through hole. The thermal insulation member includes a receiving surface located below an upper surface of the bottom wall.

The present disclosure can provide an energy storage device that can reduce scattering of the contents of an energy storage cell contained in a material discharged from the electricity storage cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing an energy storage device according to an embodiment of the present disclosure;

FIG. 2 is a plan view schematically showing the energy storage device with an upper cover removed;

FIG. 3 is a sectional view taken along line III-III in FIG. 2;

FIG. 4 is a sectional view schematically showing a modification of a protective member;

FIG. 5 is a sectional view schematically showing a modification of a bottom wall and the protective member;

FIG. 6 is a sectional view schematically showing a modification of the bottom wall and the protective member; and

FIG. 7 is a sectional view schematically showing a modification of the protective member.

### DETAILED DESCRIPTION OF EMBODIMENTS

An embodiment of the present disclosure will be described with reference to the drawings. In the drawings referred to below, the same or corresponding members are denoted by the same signs.

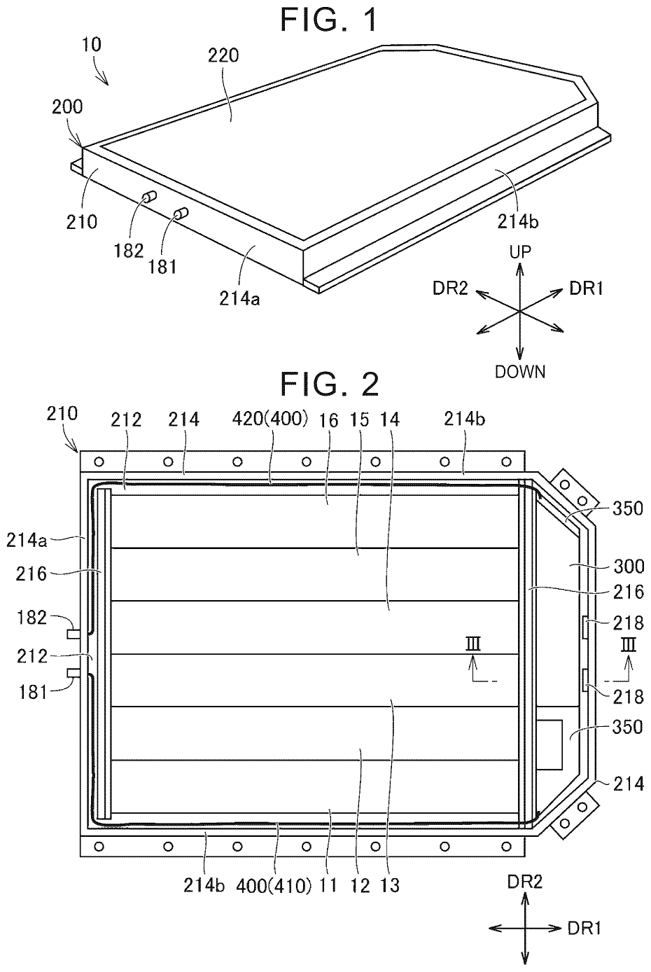

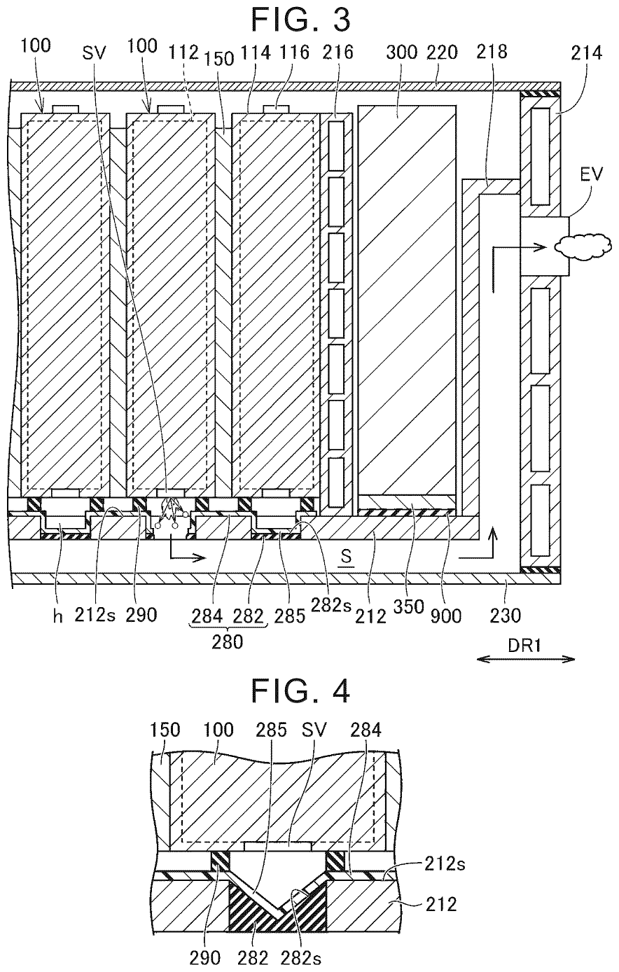

FIG. 1 is a schematic perspective view of an energy storage device according to an embodiment of the present disclosure. FIG. 2 is a plan view schematically showing the energy storage device with an upper cover removed. FIG. 3 is a sectional view taken along line III-III in FIG. 2.

An energy storage device 10 in the present embodiment is mounted in, for example, a lower part of a vehicle. The vehicle is, for example, a hybrid electric vehicle, a plug-in hybrid electric vehicle, or a battery electric vehicle.

As shown in FIGS. 1 to 3, the energy storage device 10 includes six energy storage stacks 11 to 16, a housing 200, a protective member 280, a surrounding member 290, devices 300, a device cooler 350, and a cooling medium pipe 400. The number of energy storage stacks is not limited to six.

Each of the energy storage stacks 11 to 16 is in the shape of a rectangular parallelepiped that is elongated in a first direction DR1. As shown in FIG. 2, the six energy storage stacks 11 to 16 are arranged along a second direction DR2 that is perpendicular to both the first direction DR1 and an up-down direction. In the present embodiment, the first direction DR1 corresponds to the front-rear direction of the vehicle, and the second direction DR2 corresponds to the left-right direction (width direction) of the vehicle. Each of the energy storage stacks 11 to 16 includes at least one energy storage cell 100. In the present embodiment, each of the energy storage stacks 11 to 16 includes a plurality of energy storage cells 100 and a plurality of cooling plates 150.

The energy storage cells 100 are arranged along the first direction DR1. As shown in FIG. 3, each energy storage cell 100 includes an electrode assembly 112, a cell case 114, and a pair of external terminals 116.

The electrode assembly 112 may be a wound electrode assembly in which a cathode sheet and an anode sheet are wound with a separator interposed therebetween, or may be a stacked electrode assembly in which a cathode sheet and an anode sheet are stacked with a separator interposed therebetween. The electrode assembly 112 is in a shape that is elongated in the second direction DR2.

The cell case 114 houses the electrode assembly 112. The cell case 114 is in the shape of a rectangular parallelepiped. The cell case 114 is made of a metal such as aluminum. A safety valve SV is provided in the lower surface of the cell case 114.

The external terminals 116 are provided on the outer surface of the cell case 114. In the present embodiment, the external terminals 116 are provided on the upper surface of the cell case 114. The external terminals 116 are provided at positions separated from each other in the width direction of the cell case 114. The width direction of the cell case 114 corresponds to the second direction DR2.

As shown in FIG. 3, each cooling plate 150 is disposed between a corresponding pair of energy storage cells 100 adjacent to each other in the first direction DR1. Each cooling plate 150 is in the shape of a flat plate that is elongated in the second direction DR2. Each cooling plate 150 has a channel (not shown) for a cooing medium along the second direction DR2.

The housing 200 houses the six energy storage stacks 11 to 16. As shown in FIGS. 1 to 3, the housing 200 includes a lower case 210, an upper cover 220, and a panel member 230.

The lower case 210 is open upward. The lower case 210 may be made of a metal such as aluminum. The lower case 210 includes a bottom wall 212, a peripheral wall 214, and a pair of partition walls 216.

The bottom wall 212 is located below the energy storage stacks 11 to 16. In the present embodiment, the bottom wall 212 is in the shape of a solid flat plate. However, the bottom wall 212 may be hollow. The bottom wall 212 may be formed by extrusion molding. As shown in FIG. 3, the bottom wall 212 has a plurality of through holes h. Each through hole h is provided at a position facing a corresponding safety valve SV. The length of the through hole h in the first direction DR1 is greater than the length of the safety valve SV in the first direction DR1.

The protective member 280 is provided on the bottom wall 212. As shown in FIG. 3, the protective member 280 includes a plurality of thermal insulation members 282 and a holding sheet 284.

Each thermal insulation member 282 is provided within a corresponding through hole h. Each thermal insulation member 282 includes a receiving surface 282s located below an upper surface 212s of the bottom wall 212. Each thermal insulation member 282 is shaped to close a corresponding through hole h. In the present embodiment, the lower surfaces of the thermal insulation members 282 are set to be flush with the lower surface of the bottom wall 212. Each thermal insulation member 282 serves to protect a corresponding energy storage cell 100 from the gas discharged from a corresponding safety valve SV. The thermal insulation members 282 are made of, for example, mica obtained by thermally pressing a natural inorganic mineral.

The holding sheet 284 holds the thermal insulation members 282. The holding sheet 284 is made of, for example, polypropylene. The holding sheet 284 includes adhesive portions 285 each bonded to a corresponding receiving surface 282s below the upper surface 212s of the bottom wall 212. The back surface of the holding sheet 284 may be bonded to the inner peripheral surfaces of the bottom wall 212, each surrounding a corresponding through hole h.

The surrounding member 290 is provided between the lower surface of each energy storage cell 100 and the upper surface 212s of the bottom wall 212. The surrounding member 290 is shaped to surround each through hole h. In the present embodiment, the surrounding member 290 is provided between the bottom surface of each cell case 114 and the holding sheet 284. The lower surface of the surrounding member 290 is in contact with the holding sheet 284 located on the upper surface 212s of the bottom wall 212. The upper surface of the surrounding member 290 may be in contact with the bottom surfaces of the cell cases 114. The surrounding member 290 is made of, for example, resin or metal. The surrounding member 290 may be in contact with the lower surfaces of the cooling plates 150.

The peripheral wall 214 stands from the periphery of the bottom wall 212. The peripheral wall 214 is shaped to surround the energy storage stacks 11 to 16. The peripheral wall 214 may be hollow. The peripheral wall 214 includes a front wall 214a and a pair of side walls 214b.

The front wall 214a is formed on one side (the left side in FIG. 2) of the energy storage stacks 11 to 16 in the first direction DR1. The front wall 214a extends in the second direction DR2. In the present embodiment, the one side in the first direction DR1 corresponds to the front side in the front-rear direction of the vehicle.

The side walls 214b face each other at a distance in the second direction DR2. The side walls 214b extend in the first direction DR1. An end (front end) of each side wall 214b on the one side in the first direction DR1 is connected to the front wall 214a.

The partition walls 216 divide the space surrounded by the bottom wall 212 and the peripheral wall 214 into a space in which the energy storage stacks 11 to 16 are disposed and the remaining space. The partition walls 216 are disposed spaced apart from each other in the first direction DR1. The partition walls 216 extend in the second direction DR2. The partition walls 216 may be hollow. The partition walls 216 serve to restrain the energy storage stacks 11 to 16 from both sides in the first direction DR1. As shown in FIG. 2, each end in the second direction DR2 of the partition wall 216 located on the one side (front side) in the first direction DR1 is spaced apart from a corresponding side wall 214b. Each end in the second direction DR2 of the partition wall 216 located on the other side (rear side) in the first direction DR1 is connected to a corresponding side wall 214b.

The upper cover 220 is disposed above the energy storage stacks 11 to 16. The upper cover 220, together with the lower case 210, houses the six energy storage stacks 11 to 16. Specifically, the upper cover 220, together with the lower case 210, houses the six energy storage stacks 11 to 16 in a sealed state. The periphery of the upper cover 220 is connected to the upper end of the peripheral wall 214 with a sealing member interposed therebetween by using bolts etc.

The panel member 230 is provided below the lower case 210. The panel member 230 serves to protect the bottom wall 212 of the lower case 210. The panel member 230 may be in the shape of a flat plate. The periphery of the panel member 230 is connected to the lower surface of the lower case 210 with a sealing member interposed therebetween.

As shown in FIG. 3, a space S is formed between the panel member 230 and the bottom wall 212. The space S serves as an exhaust path (hereinafter referred to as “exhaust path S”). The exhaust path S is a path for discharging gas discharged from the safety valves SV of the energy storage cells 100 to the outside of the housing 200.

As shown in FIGS. 2 and 3, an exhaust duct 218 is formed on the peripheral wall 214. The exhaust duct 218 extends upward from the bottom wall 212. The exhaust duct 218 guides the gas upward from the exhaust path S. An explosion-proof valve EV is provided at the downstream end of the exhaust duct 218. The explosion-proof valve EV releases the pressure within the housing 200. The explosion-proof valve EV opens when the pressure within the housing 200 becomes equal to or greater than a reference value. The explosion-proof valve EV is constituted by a check valve. As shown in FIG. 3, when gas is discharged from any of the energy storage cells 100, the gas travels in the first direction DR1 through the exhaust path S and is discharged to the outside of the housing 200 through the exhaust duct 218 and the explosion-proof valve EV.

The devices 300 are housed in the housing 200. As shown in FIG. 2, the devices 300 are disposed on the other side of the lower case 210 in the first direction DR1, that is, in the space formed between the partition wall 216 located on the other side (rear side) in the first direction DR1 and the peripheral wall 214. The devices 300 may include a junction box. The devices 300 may include a relay, a control device, etc.

The device cooler 350 cools the devices 300. As shown in FIGS. 2 and 3, the device cooler 350 is provided between the bottom wall 212 and the devices 300. A thermally conductive adhesive 900 may be provided between the device cooler 350 and the bottom wall 212.

The cooling medium pipe 400 is routed inside the housing 200. The cooling medium pipe 400 is connected to the cooling plates 150 and the device cooler 350. As shown in FIGS. 1 and 2, the front wall 214a of the peripheral wall 214 is provided with an inlet port 181 and an outlet port 182. The cooling medium pipe 400 is connected to the inlet port 181 and the outlet port 182. Therefore, the cooling medium (such as water or oil) supplied from the inlet port 181 flows into the cooling plates 150 and the device cooler 350 through the cooling medium pipe 400, cools the energy storage cells 100 and the devices 300, and then flows out from the outlet port 182 through the cooling medium pipe 400.

As shown in FIG. 2, the cooling medium pipe 400 includes an upstream pipe 410 and a downstream pipe 420.

The upstream end of the upstream pipe 410 is connected to the inlet port 181. The downstream end of the upstream pipe 410 is connected to one end of the device cooler 350 in the second direction DR2. The upstream pipe 410 is routed to pass between the front wall 214a and the partition wall 216 located on the one side in the first direction DR1, and between the energy storage stack 11 disposed on one side in the second direction DR2 and the side wall 214b. The upstream pipe 410 is connected to one end of each cooling plate 150 in the second direction DR2.

The upstream end of the downstream pipe 420 is connected to the other end of the device cooler 350 in the second direction DR2. The downstream end of the downstream pipe 420 is connected to the outlet port 182. The downstream pipe 420 is routed to pass between the front wall 214a and the partition wall 216 located on the one side in the first direction DR1, and between the energy storage stack 16 disposed on the other side in the second direction DR2 and the side wall 214b. The downstream pipe 420 is connected to the other end of each cooling plate 150 in the second direction DR2.

In the energy storage device 10 described above, when any material is discharged downward from the safety valve SV due to a short circuit etc. in any of the energy storage cells 100, the discharged material flows into the through hole h and strikes the adhesive portion 285 and the receiving surface 282s. As a result, the adhesive portion 285 melts and the thermal insulation member 282 cracks open, allowing the discharged material containing the contents (so-called debris) of the energy storage cell 100 to flow into the exhaust path S. Thereafter, gas contained in the discharged material travels through the exhaust path S and is discharged from the housing 200 through the explosion-proof valve EV as shown in FIG. 3.

Hereinafter, modifications of the above embodiment will be described.

### First Modification

As shown in FIG. 4, the receiving surface 282s of the thermal insulation member 282 may have a tapered shape that gradually slopes downward toward the center in the first direction DR1.

### Second Modification

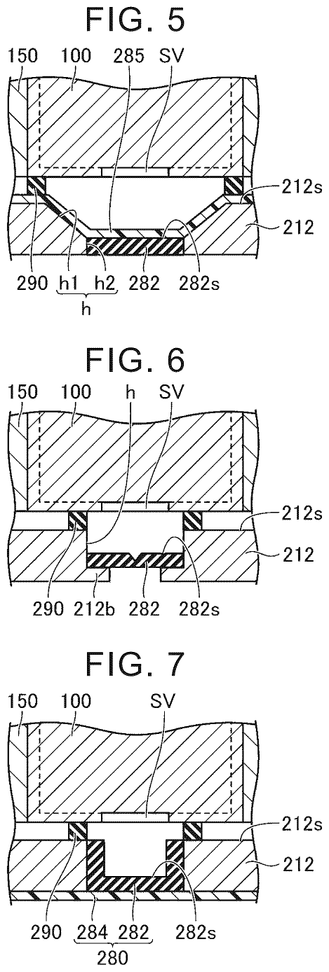

As shown in FIG. 5, the through hole h may include a tapered portion h1 and a holding portion h2. The tapered portion h1 gradually decreases in diameter from the upper surface 212s of the bottom wall 212 downward. The holding portion h2 extends downward from the lower end of the tapered portion h1 and holds the thermal insulation member 282.

In this aspect, the contents of the energy storage cell 100 more reliably flow into the through hole h.

### Third Modification

As shown in FIG. 6, the bottom wall 212 may include a support portion 212b. The support portion 212b protrudes inward from the lower end of the inner peripheral surface of the bottom wall 212 that surrounds the through hole h. The support portion 212b supports the thermal insulation member 282.

### Fourth Modification

As shown in FIG. 7, the holding sheet 284 may be fixed to the lower surface of the bottom wall 212 by adhesive bonding etc. In this example, the thermal insulation member 282 is supported from below by the holding sheet 284.

### Fifth Modification

Although not shown in the figures, the pair of external terminals 116 may be provided on the lower surface of the cell case 114. In this case, a busbar (not shown) that connects the external terminals 116 of a pair of adjacent energy storage cells 100 is disposed between the bottom wall 212 and the energy storage cells 100. In this case, the surrounding member 290 is provided inward of the pair of external terminals 116 and the busbar.

In this aspect, the material discharged from the safety valve SV is less likely to adhere to the external terminals 116 and the busbar.

It will be understood by a person skilled in the art that the exemplary embodiment described above is a specific example of the following aspects.

### First Aspect

An energy storage device includes: at least one energy storage cell; a bottom wall disposed below the at least one energy storage cell; a panel member provided below the bottom wall and defining, together with the bottom wall, an exhaust path; and a protective member provided on the bottom wall. A safety valve is provided in a lower surface of the at least one energy storage cell. The bottom wall has a through hole provided at a position facing the safety valve. The protective member includes a thermal insulation member provided within the through hole. The thermal insulation member includes a receiving surface located below an upper surface of the bottom wall.

In this energy storage device, the thermal insulation member provided within the through hole includes the receiving surface located below the upper surface of the bottom wall. This allows the contents of the energy storage cell contained in a material discharged from the energy storage cell to effectively flow into the through hole. Therefore, scattering of the contents of the energy storage cell is reduced.

### Second Aspect

In the energy storage device according to the first aspect, the protective member further includes a holding sheet that holds the thermal insulation member, and the holding sheet includes an adhesive portion bonded to the receiving surface below the upper surface of the bottom wall.

In this aspect, scattering of the contents of the energy storage cell is reduced and falling of the thermal insulation member through the through hole is reduced.

### Third Aspect

In the energy storage device according to the first or second aspect, the through hole includes a tapered portion that gradually decreases in diameter from the upper surface of the bottom wall downward, and a holding portion that extends downward from a lower end of the tapered portion and holds the thermal insulation member.

In this aspect, the contents of the energy storage cell more reliably flow into the through hole.

### Fourth Aspect

The energy storage device according to any one of the first to third aspects further includes a surrounding member provided between the at least one energy storage cell and the bottom wall and shaped to surround the through hole.

In this aspect, the contents of the energy storage cell more reliably flow into the through hole.

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. An energy storage device comprising:
at least one energy storage cell;
a bottom wall disposed below the at least one energy storage cell;
a panel member provided below the bottom wall and defining, together with the bottom wall, an exhaust path; and
a protective member provided on the bottom wall, wherein:
a safety valve is provided in a lower surface of the at least one energy storage cell;
the bottom wall has a through hole provided at a position facing the safety valve;
the protective member includes a thermal insulation member provided within the through hole; and
the thermal insulation member includes a receiving surface located below an upper surface of the bottom wall.

2. The energy storage device according to claim 1, wherein:
the protective member further includes a holding sheet that holds the thermal insulation member; and
the holding sheet includes an adhesive portion bonded to the receiving surface below the upper surface of the bottom wall.

3. The energy storage device according to claim 1, wherein
the through hole includes
a tapered portion that gradually decreases in diameter from the upper surface of the bottom wall downward, and
a holding portion that extends downward from a lower end of the tapered portion and holds the thermal insulation member.

4. The energy storage device according to claim 1, further comprising a surrounding member provided between the at least one energy storage cell and the bottom wall and shaped to surround the through hole.
